(19) United States
(12) Patent Application Publication
(10) Pub. No.: US 2011/0317952 A1
(43) Pub. Date: Dec. 29, 2011

(54) TANDEM ANGULAR CONTACT ROLLER BEARING WITH CONCAVE ROLLER PROFILE FOR IMPROVED ROLLER GUIDANCE

(75) Inventors: Michael Heaton, Rock Hill, SC (US); Seth Claus, Charlotte, NC (US); Dennis Roffe, Tega Cay, SC (US); David Cessna, Tega Cay, SC (US)

(73) Assignee: SCHAEFFLER TECHNOLOGIES GMBH & CO. KG, Herzogenaurach (DE)

(21) Appl. No.: 12/825,667

(22) Filed: Jun. 29, 2010

(51) Int. Cl. F16C 33/34

(52) U.S. Cl. 384/568

(57) ABSTRACT

A tandem roller bearing having circumferential inner and outer races each having first and second contact surfaces with convex profiles is provided. Rolling elements are arranged between the inner and outer races, each of the rolling elements having a concave profile corresponding to the convex profiles of a respective pairing of the first contact surfaces of the inner and outer races or of the second contact surfaces of the inner and outer races. A cage is arranged between the inner and outer races that separates and is guided by the rolling elements. The rolling elements include first and second sets of rolling elements having first and second axes of rotation that are arranged between the first and second contact surfaces of the inner and outer races, respectively. The first and second axes of rotation are inclined in a same direction with respect to a central axis of the inner race.

### FIELD OF INVENTION

This application is generally related to roller bearings and more particularly related to tandem angular contact roller bearings.

### BACKGROUND

Roller bearings are widely used in various mechanical applications, including the automotive field. For example, shaft support bearings are often used in transmissions and other gear boxes such as power take-out units and differentials where friction reduction and efficiency gains are desired. Common types of bearing design include ball bearings that use spherical rolling elements, roller bearings that use wide cylindrical rolling elements, needle bearings that use thin cylindrical rolling elements, and tapered roller bearings that use conical rollers that run on conical races. Each of these types of roller bearings has its advantages and drawbacks, and is designed to support different loads.

Another type of bearing design, known as a spherical roller bearing, uses rolling elements in the shape of cylinders that are thicker in the middle and thinner at the ends, with substantially flat end surfaces. In other words, each of the rolling elements has a convex profile, which offers a space saving advantage over spherical rolling elements. The races of the spherical roller bearing are formed with concave surfaces that correspond to the rolling elements' convex profiles. Arranging the rolling elements of a spherical roller bearing at an angle allows the bearing to handle both radial and axial loads. A tandem angular contact spherical roller bearing includes two rows of rolling elements arranged at different pitch angles, which can be set to support misaligned loads. However, because of the rolling elements' non-uniform shape, during rotation gyroscopic forces cause the rolling elements to turn radially inward or outward towards the roller bearing's cages. This additional force exerted by the rolling elements on the cages is undesirable, as it increases friction in the roller bearing and decreases the life of the cages, which are usually made out of plastic and are unsuited for supporting loads. Therefore, a need exists for a tandem angular contact roller bearing design having the advantages of known designs, but with reduced forces on the cages during operation.

### SUMMARY

A tandem roller bearing is disclosed having a circumferential inner race with first and second contact surfaces, each having a convex profile, and a circumferential outer race surrounding the circumferential inner race. The outer race also includes first and second contact surfaces each having a convex profile. Rolling elements are arranged between the inner race and the outer race to support the outer race on the inner race during rotation. Each of the rolling elements has a concave profile that corresponds to the convex profiles of a respective pairing of the first contact surfaces of the inner and outer races or of the second contact surfaces of the inner and outer races. A cage is arranged between the inner and outer races to separate and guide the rolling elements during rotation of the outer race with respect to the inner race. The rolling elements include a first set of rolling elements having first axes of rotation that are arranged between the first contact surfaces of the inner and outer races, and a second set of rolling elements having second axes of rotation that are arranged between the second contact surfaces of the inner and outer races. The first and second axes of rotation are inclined in a same direction with respect to a central axis of the inner race.

In other embodiments of the tandem roller bearing, the cage may include a first cage that separates and guides the first set of rolling elements and a second cage that separates and guides the second set of rolling elements. The first and second cages may each include a circumferential rim and protrusions that extend from the rim to form pockets for the rolling elements, each of the pockets having a convex profile that corresponds to the concave profile of the rolling elements. The first and second axes of rotation of the first and second sets of rolling elements may be substantially parallel to one another. Alternatively, the second axes of rotation may have a greater inclination with respect to the central axis of the inner race than the first axes of rotation. In addition, each of the rolling elements may include a first end and a second end that are substantially flat. For sake of brevity, this summary does not list all aspects of the present device, which are described in further detail below and in the appended claims.

### BRIEF DESCRIPTION OF THE DRAWINGS

FIG. 1 is a perspective view of an embodiment of the tandem roller bearing.

FIG. 2 is a perspective view of the tandem roller bearing shown in FIG. 1 without an inner race.

FIG. 3 is a side elevational view of the inner race of the tandem roller bearing shown in FIG. 1.

FIG. 4 is a perspective view of first and second cages and rolling elements of the tandem roller bearing shown in FIG. 1.

FIG. 5 is a cross-sectional view of the tandem roller bearing shown in FIG. 1 taken along line 5-5 of FIG. 1.

FIG. 6 is a perspective view of rolling elements of the tandem roller bearing shown in FIG. 1.

### DETAILED DESCRIPTION OF THE PREFERRED EMBODIMENTS

Certain terminology is used in the following description for convenience only and is not limiting. The words “inner,” “outer,” “inwardly,” and “outwardly” refer to directions towards and away from the parts referenced in the drawings. A reference to a list of items that are cited as “as least one of a, b or c” (where a, b and c represent the items being listed) means any single one of the items a, b, c or combinations thereof. The terminology includes the words specifically noted above, derivates thereof, and words of similar import.

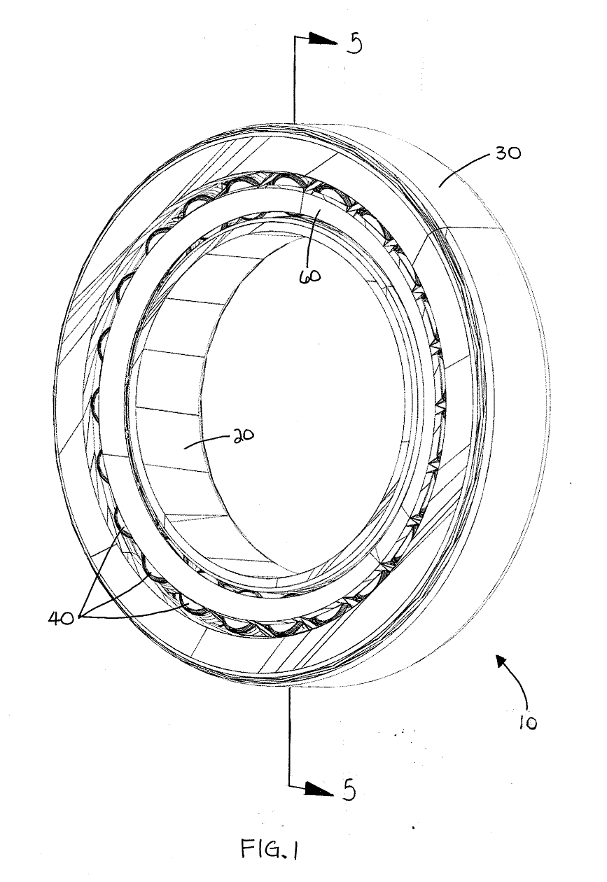

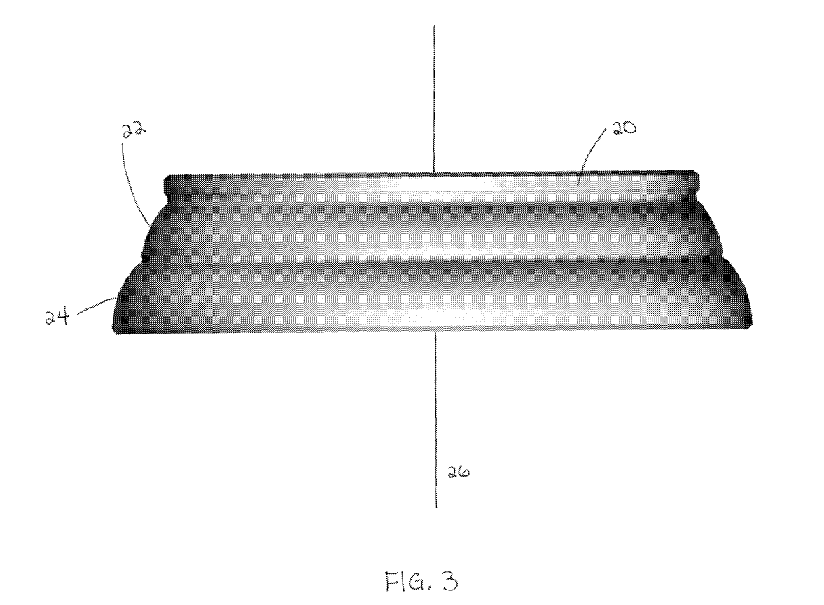

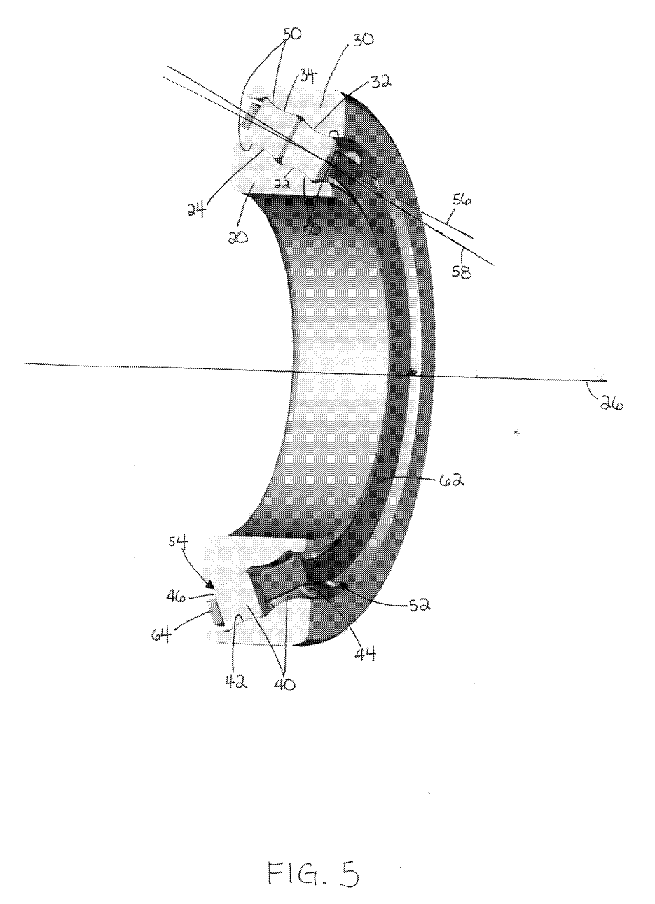

FIGS. 1-6 show a preferred embodiment of the tandem roller bearing 10 according to the present invention. As shown in FIGS. 1 and 5, the tandem roller bearing 10 includes a circumferential inner race 20 surrounded by a circumferential outer race 30, with rolling elements 40 arranged therebetween to support the outer race 30 on the inner race 20 during rotation. As shown in FIGS. 3 and 5, the inner race 20 includes first and second contact surfaces 22, 24, each having a convex profile. The outer race 30 also includes first and second contact surfaces 32, 34, each having a convex profile. The inner and outer races 20, 30 can be made from any suitable material having the desired hardness and load bearing characteristics, such as, for example and without limitation, through hardened or case hardened steel. Processes for forming the inner and outer races 20, 30 are well known. For example, the inner and outer races 20, 30 may be turned from steel bars or tubing, ground to form the first and second contact surfaces 22, 32, 24, 34, heat treated to achieve a desired hardness, and then finished.

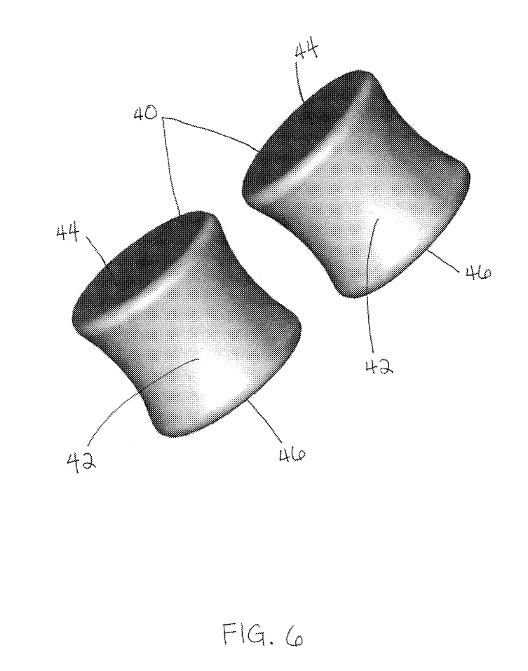

As shown in FIG. 6, each of the rolling elements 40 has a concave profile 42 that corresponds to the convex profiles of a respective pairing 50 of the first contact surfaces 22, 32 of the inner and outer races 20, 30, or of the second contact surfaces 24, 34 of the inner and outer races 20, 30 (as shown in FIG. 5). Each of the rolling elements 40 also has a first end 44 and a second end 46 that are substantially flat. The preferred material for the rolling elements 40 is hardened steel.

Referring to FIGS. 1, 2, 4 and 5, a cage 60 is arranged between the inner race 20 and the outer race 30 and guides the rolling elements 40 during rotation of the outer race 30 with respect to the inner race 20. The cage 60 acts as a spacer between the rolling elements 40, and generally does not carry any load. The cage 60 may be formed from any suitable material, including plastics and metals. Forming the cage 60 from plastic materials can reduce the overall weight of the tandem roller bearing 10.

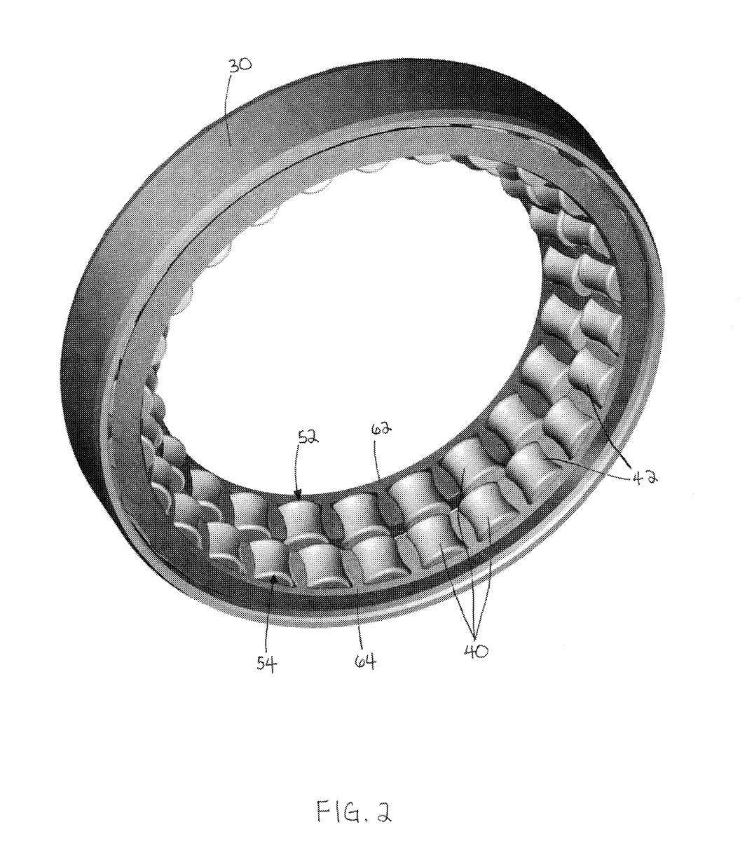

As shown in FIGS. 2, 4 and 5, the rolling elements 40 includes a first set of rolling elements 52 having first axes of rotation 56 and arranged between the first contact surfaces 22, 32 of the inner and outer races 20, 30. The rolling elements 40 further includes a second set of rolling elements 54 having second axes of rotation 58 and arranged between the second contact surfaces 24, 34 of the inner and outer races 20, 30. The first and second axes of rotation 56, 58 are inclined in a same direction with respect to a central axis 26 of the inner race 20. The first and second axes of rotation 56, 58 may be substantially parallel to one another. Alternatively, as shown in FIG. 5, the second axes of rotation 58 may have a greater inclination with respect to the central axis 26 of the inner race 20 than the first axis of rotation 56. The second set of rolling elements 54 has a greater pitch diameter than the first set of rolling elements 52. Although not illustrated in the drawings, alternate embodiments of the present tandem roller bearing may include additional sets of rolling elements arranged in different rows from the first and second set of rolling elements 52, 54 to form triple-row or quadruple-row roller bearings.

The configuration of the rolling elements 40 and inner and outer races 20, 30 of the present tandem roller bearing 10 significantly reduces the undesirable forces exerted on the cage 60, as compared to known tandem roller bearings having rolling elements with convex profiles. Specifically, when the rolling elements 40 experience gyroscopic forces during rotation and begin to turn radially inward or outward towards the cage 60, the concave profiles 42 of the rolling elements 40 allow the resultant forces to be placed on the convex profiles of the first and second contact surfaces 22, 32, 24, 34 of the inner and outer races 20, 30, which are formed from materials more suited to carrying loads than the cage 60. In contrast to known tandem roller bearings, which rely heavily on the cage to guide the rolling elements, the present tandem roller bearing 10 uses inner and outer races 20, 30 to guide and prevent the rolling elements 40 from turning radially inward or outward.

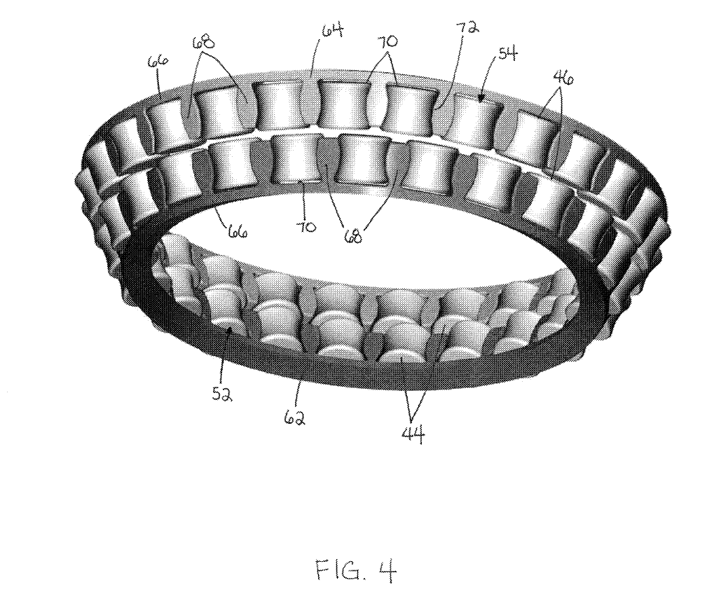

As shown in FIGS. 2 and 4, the cage 60 may include a first cage 62 that separates and guides the first set of rolling elements 52 and a second cage 64 that separates and guides the second set of rolling elements 54. The first and second cages 62, 64 may be formed with an “open pocket” design. In other words, each of the first and second cages 62, 64 includes a circumferential rim 66 and protrusions 68 that extend from the rim to form pockets 70 for the rolling elements 40 that are open on one side. Each of the pockets 70 has a convex profile 72 that corresponds to the concave profile 42 of the rolling elements 40. If the cage 60 is made from plastic materials, an injection molding process can be used to form first and second cages 62, 64 with the desired convex profile 72. This “snap pocket” design allows the rolling elements 40 to be retained in the pockets 70 of the first and second cages 62, 64 such that the rolling elements 40 can rotate and are axially retained within the pockets 70. The first and second cages 62, 64 can be arranged with their rims 66 facing outwardly so that the pockets 70 of the first cage 62 face the pockets 70 of the second cage 64, which help prevent foreign particles from entering the pockets 70 and interfering with operation of the rolling elements 40. In an alternative embodiment of the tandem roller bearing, which is not illustrated in the drawings, the first and second cages 62, 64 may be formed with “closed pockets” that surround the rolling elements 40 on all sides about a given axis.

As discussed above, the rolling elements 40 include first and second sets of rolling elements 52, 54, which can be formed with different concave profiles 42. Thus, the concave profile 42 of each of the rolling elements 40, the convex profiles of the first and second contact surfaces 22, 24 of the inner race 20, and the convex profiles of the first and second contact surfaces 32, 34 of the outer race 30 can be optimized to meet various desired performance characteristics, depending on the specific application. For example, the concave profiles 42 of the rolling elements 40 and the convex profiles of the inner and outer races 20, 30 can be optimized to minimize friction between the rolling elements 40 and the cage 60 during operation of the tandem roller bearing. Since the present tandem roller bearing 10 shifts the gyroscopic forces experienced by the rolling elements 40 to the inner and outer races 20, 30, the various profiles can be optimized to minimize friction between the rolling elements 40 and the first and second contact surfaces 22, 32, 24, 34 of the inner and outer races 20, 30 during operation. Furthermore, the various profiles can be optimized to simultaneously reduce contact pressure between the rolling elements 40 and the cage 60, and increase contact pressure between the rolling elements 40 and the first and second contact surfaces 22, 32, 24, 34 of the inner and outer races 20, 30. In addition, the various profiles can be optimized to increase the load capacity of the tandem roller bearing 10 for a given envelope, which is defined by the inner diameter, outer diameter, and the width of a bearing.

For example, simulation analysis of a standard tandem roller bearing having rolling elements with convex profiles and the tandem roller bearing of the present invention having rolling elements with concave profiles shows how optimization of the rolling elements' concave profiles can significantly increase the load carrying capacity of the roller bearing. As shown in the tables and chart below, a rolling element of a standard tandem roller bearing having a convex profile, a rolling element diameter of 9.525 mm, and supported on an inner race with a curvature radius of −4.953 mm and rolling contact radius of 27.594 mm reaches its maximum contact pressure of 4200 N/mm2 at a load of 6,737 N (as shown in Table 1). A rolling element of the present tandem roller bearing having a concave profile with the same rolling element diameter, race curvature radius, and rolling contact radius reaches the maximum contact pressure of 4200 N/mm2 at approximately the same load (as shown in Table 2). The inner race's rolling contact radius is the distance from the center of the inner race to the radially outmost point of the inner race's convex profile. However, as shown by optimizations 1-5 in the chart below, optimization of the present rolling element's concave profile and the inner race's convex profile by varying the rolling element's minimum radius, its concave curvature radius, and the race curvature radius, while keeping the inner race's rolling contact radius the same at 27.594 mm, can increase the load at which the rolling element reaches the maximum contact pressure of 4200 N/mm². As shown in Table 3 and optimization 5 of the chart below, a rolling element of the present tandem roller bearing having a concave profile with a concave curvature radius of 20 mm, a minimum radius of 6 mm, and a race curvature radius of 19.2 mm can support a load of greater than 20,000 N before reaching the maximum contact pressure of 4200 N/mm². In other words, for a given envelope having an inner race rolling contact radius of 27.594 mm, a rolling element of the present tandem roller bearing with a concave profile can support more than 13,000 N of additional load than a rolling element of a standard tandem roller bearing with a convex profile. In addition, at a load of approximately 5,000 N, optimization of the rolling element's concave profile and the inner race's convex profile can decrease the contact pressure of the rolling element by approximately 30% as compared to that of a standard tandem roller bearing (as shown in Tables 1 and 3).

TABLE 1
Standard Tandem Roller Bearing With
Convex Rolling Elements

| Load (N) | Contact Pressure (N/mm₂) | |
|---|---|---|
| 0 | 0 | |
| 1000 | 2225 | |
| 2000 | 2803 | |
| 3000 | 3209 | |
| 4000 | 3532 | |
| 5000 | 3804 | |
| 6000 | 4043 | |
| 7000 | 4256 | |
| 8000 | 4450 | |
| 9000 | 4628 | |
| 10000 | 4793 | |
| Rolling element | 9.525 | mm |
| diameter | | |
| Rolling element | 4.763 | mm |
| convex curvature | | |
| radius | | |
| Raceway curvature | −4.753 | mm |
| radius | | |
| Rolling contact | 27.594 | mm |

radius

TABLE 2
Present Tandem Roller Bearing With
Concave Rolling Elements

| Load (N) | Contact Pressure (N/mm₂) | |
|---|---|---|
| 0 | 0 | |
| 1000 | 2265 | |
| 2000 | 2854 | |
| 3000 | 3267 | |
| 4000 | 3596 | |
| 5000 | 3873 | |
| 6000 | 4116 | |
| 7000 | 4333 | |
| 8000 | 4530 | |
| 9000 | 4712 | |
| 10000 | 4800 | |
| Rolling element | −4.763 | mm |
| concave curvature | | |
| radius | | |
| Rolling element | 4.763 | mm |
| minimum radius | | |
| Raceway curvature | 4.572 | mm |
| radius | | |
| Rolling contact | 27.594 | mm |

radius

TABLE 3
Optimized Tandem Roller Bearing With Concave
Rolling Elements (Optimization 5)

| Load (N) | Contact Pressure (N/mm₂) | |
|---|---|---|
| 0 | 0 | |
| 1000 | 2265 | |
| 2000 | 2854 | |
| 3000 | 3267 | |
| 4000 | 3596 | |
| 5000 | 3873 | |
| 6000 | 4116 | |
| 7000 | 4333 | |
| 8000 | 4530 | |
| 9000 | 4712 | |
| 10000 | 4800 | |
| Rolling element | −20 | mm |
| concave curvature | | |
| radius | | |
| Rolling element | 6 | mm |
| minimum radius | | |
| Raceway curvature | 19.2 | mm |
| radius | | |
| Rolling contact | 27.594 | mm |

radius

The above are only some examples of how the concave profile 42 of each of the rolling elements 40, the convex profiles of the first and second contact surfaces 22, 24 of the inner race 20, and the convex profiles of the first and second contact surfaces 32, 34 of the outer race 30 can be optimized, and additional optimizations can be achieved by changing the various profiles to meet specific needs.

Having thus described various embodiments of the present chain in detail, it is to be appreciated and will be apparent to those skilled in the art that many physical changes, only a few of which are exemplified in the detailed description above, could be made in the apparatus without altering the inventive concepts and principles embodied therein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

What is claimed is:

1. A tandem roller bearing comprising:
a circumferential inner race having first and second contact surfaces each having a convex profile;
a circumferential outer race surrounding the circumferential inner race, the outer race having first and second contact surfaces each having a convex profile;
rolling elements arranged between the inner race and the outer race to support the outer race on the inner race during rotation, each of the rolling elements having a concave profile that corresponds to the convex profiles of a respective pairing of the first contact surfaces of the inner and outer races or of the second contact surfaces of the inner and outer races;
a cage arranged between the inner race and the outer race that separates and is guided by the rolling elements during rotation of the outer race with respect to the inner race; and
the rolling elements include a first set of rolling elements having first axes of rotation that are arranged between the first contact surfaces of the inner and outer races, and a second set of rolling elements having second axes of rotation that are arranged between the second contact surfaces of the inner and outer races, the first and second axes of rotation being inclined in a same direction with respect to a central axis of the inner race.

2. The tandem roller bearing of claim 1, wherein the cage comprises a first cage that separates and is guided by the first set of rolling elements and a second cage that separates and is guided by the second set of rolling elements.

3. The tandem roller bearing of claim 2, wherein the first and second cages each includes a circumferential rim and protrusions that extend from the rim to form pockets for the rolling elements, each of the pockets having a convex profile that corresponds to the concave profile of the rolling elements.

4. The tandem roller bearing of claim 3, wherein the rolling elements are retained in the pockets of the first and second cages such that the rolling elements can rotate and are axially retained within the pockets.

5. The tandem roller bearing of claim 3, wherein the pockets of the first cage face the pockets of the second cage.

6. The tandem roller bearing of claim 1, wherein the first and second axes of rotation are substantially parallel to one another.

7. The tandem roller bearing of claim 1, wherein the second axes of rotation have a greater inclination with respect to the central axis of the inner race than the first axes of rotation.

8. The tandem roller bearing of claim 1, wherein each of the rolling elements has a first end and a second end that are substantially flat.

9. The tandem roller bearing of claim 8, wherein the concave profile of each of the rolling elements, the convex profiles of the first and second contact surfaces of the inner race, and the convex profiles of the first and second contact surfaces of the outer race are optimized to minimize friction between the rolling elements and the cage.

10. The tandem roller bearing of claim 8, wherein the concave profile of each of the rolling elements, the convex profiles of the first and second contact surfaces of the inner race, and the convex profiles of the first and second contact surfaces of the outer race are optimized to minimize friction between the rolling elements and the first and second contact surfaces of the inner and outer races.

11. The tandem roller bearing of claim 8, wherein the concave profile of each of the rolling elements, the convex profiles of the first and second contact surfaces of the inner race, and the convex profiles of the first and second contact surfaces of the outer race are optimized to increase load capacity of the tandem roller bearing.

12. The tandem roller bearing of claim 8, wherein the concave profile of each of the rolling elements, the convex profiles of the first and second contact surfaces of the inner race, and the convex profiles of the first and second contact surfaces of the outer race are optimized to reduce contact pressure between the rolling elements and the cage, and increase contact pressure between the rolling elements and the first and second contact surfaces of the inner and outer races during rotation of the rolling elements.
